(19) United States
(12) Patent Application Publication
(10) Pub. No.: US 2026/0211934 A1
(43) Pub. Date: Jul. 23, 2026

(54) SYSTEM AND METHODS FOR AUTOMATICALLY DETECTING MACHINE GENERATED TEXT

(71) Applicant: Board of Regents, The University of Texas System, Austin, TX (US)

(72) Inventors: Emet Bethany, San Antonio, TX (US); Mazal Bethany, San Antonio, TX (US); Peyman Najafirad, San Antonio, TX (US); Anthony Rios, San Antonio, TX (US); Nishant Vishwamitra, San Antonio, TX (US); Brandon Wherry, San Antonio, TX (US)

(21) Appl. No.: 19/452,366

(22) Filed: Jan. 18, 2026

Related U.S. Application Data
(60) Provisional application No. 63/746,862, filed on Jan. 17, 2025.

(51) Int. Cl. G06F 16/358; G06N 3/04; G06N 3/0895

(52) U.S. Cl. CPC G06F 16/358; G06N 3/04; G06N 3/0895

(57) ABSTRACT

In the digital age, accurately discerning human-generated text from machine-generated text is a significant challenge, with implications across various domains from cybersecurity to content authenticity. A method for automatically detecting machine generated text, comprises: receiving a plurality of text inputs; feeding the text inputs into an encoding module; converting the text inputs into feature vectors, wherein the feature vectors represent high-dimensional embeddings of the text inputs; storing the feature vectors in an text embedding database; analyzing the feature vectors using a training machine learning classifier to distinguish between human-generated and machine-generated texts; classifying the text inputs based on their respective feature vectors and analysis; and outputting a representation of the classification.

### RELATED APPLICATION

This application claims the benefit of priority under 35 U.S.C. § 119(e) to U.S. Provisional Ser. No. 63/746,862, filed Jan. 17, 2025, the entire contents of which are hereby incorporated by reference.

### FIELD OF INVENTION

This invention relates to an advanced system for discerning machine-generated text from human-generated text using sophisticated Large Language Model (LLM) encoders.

### BACKGROUND

In the rapidly evolving digital landscape, a paramount challenge has emerged: the accurate detection of machine-generated text across various platforms and applications. This challenge is critical in maintaining the integrity and authenticity of digital content, spanning areas like social media, digital forensics, academic environments, professional networking sites, and content moderation.

### SUMMARY OF THE INVENTION

The proposed system addresses the crucial need for an innovative approach to effectively discern machine-generated text from human-authored content. The proposed system leverages advancements in Large Language Model (LLM) encoders and classification techniques, offering a solution that is not only accurate and efficient but also adaptable to various domains where the authenticity of digital content is paramount.

FIGS. 1 and 2 illustrate the high-level architecture of the proposed method for effectively discerning machine-generated from human-generated text. This method leverages the sophistication of Large Language Model (LLM) encoders to generate dense and semantically rich embeddings of textual data. These encoders serve as the foundational component of our methodology, where both human and machine-generated texts are fed into the encoder to extract embeddings that capture the unique characteristics of each text type. The embeddings are then stored for further analysis. Atop these embeddings, a variety of classifiers are constructed, including Multilayer Perceptrons (MLPs), K-Nearest Neighbors (KNN), and advanced, contrastive learning-based KNN classifiers.

The proposed method utilizes an LLM text encoder to transform raw text input into high-dimensional embeddings. Embeddings are the backbone of how LLMs process and understand text, enabling them to perform a wide range of language-related tasks. These embeddings, encapsulating intricate patterns and contextual relationships, are crucial for differentiating between human-generated and machine-generated content. The use of a frozen encoder from an established LLM ensures standardized, state-of-the-art representations without the need for training a separate encoding mechanism.

Building on these rich embeddings, the methodology employs several classifiers to leverage the nuances captured within the embeddings for distinguishing between the two text types. Multilayer Perceptrons (MLPs) interpret these embeddings by modeling relationships and extracting higher-level features, thereby transforming this latent information into actionable classification decisions. The adaptability and flexibility of MLP architectures make them a natural choice for classification based on embeddings. Additionally, the K-Nearest Neighbors (KNN) classifier may be used, attributing a classification label to an unseen sample based on the predominant label of its closest neighbors. The KNN algorithm's resistance to overfitting and its ability to draw on broader data patterns make it particularly effective in focusing on subtle distinctions between human and machine-generated texts.

Another classifier that can be used utilizes contrastive learning in conjunction with the KNN classification algorithm. This technique accentuates the differences between human and machine embeddings, creating a clearer distinction in the latent space. The embeddings are further refined through fully connected layers before being used for classification. A similarity matrix and Triplet Margin Loss are employed during training to minimize the distance between positive pairs (similar origin texts) and maximize the distance between negative pairs (different origin texts) in the embedded space. Euclidean distance is used to measure the differences between these contrastively learned embeddings for KNN classification. This distance measure considers both the orientation and magnitude of vectors, providing a comprehensive evaluation of the distinctions between text embeddings and enabling effective differentiation between human and machine-generated texts.

The present invention has a variety of uses including, but not limited to the following illustrative uses:
Content Moderation on Social Media: The method can be employed to identify and filter out machine-generated posts, comments, and messages on social media platforms. This application is crucial for combating the spread of misinformation, spam, and artificially amplified narratives.
Academic Integrity and Plagiarism Detection: In educational settings, this approach can be used to detect essays, reports, or assignments generated by AI writing tools, thereby upholding academic integrity and discouraging plagiarism.
Cybersecurity and Fraud Detection: The technology can be applied in cybersecurity to identify phishing emails or fraudulent communications that are often machine-generated, enhancing the security of digital communications.
Legal and Compliance Document Review: The method can assist in differentiating between human-written and AI-generated legal documents or contracts, ensuring compliance and authenticity in legal proceedings and document verification.
Journalism and News Verification: Journalists and news agencies can use this system to verify the authenticity of articles, reports, and other written materials, ensuring that the content is not generated by AI tools, which is vital for maintaining journalistic integrity
Online Review and Feedback Analysis: In e-commerce and service industries, the method can be implemented to distinguish between genuine customer reviews and machine-generated fake reviews, aiding in maintaining the credibility of customer feedback
Market Research and Data Analysis: This approach can be utilized in market research to filter out machine-generated responses in surveys or questionnaires, ensuring the accuracy and reliability of market insights.
Creative Writing and Publishing: The system can be used by publishers and literary agents to determine if manuscripts or literary works are human-authored or AI-generated, preserving the authenticity of creative writing.
Human Resources and Recruitment: In the recruitment process, the method can help in verifying the authenticity of resumes, cover letters, and other application materials, ensuring candidates are genuinely representing their skills and experiences.
Digital Forensics and Investigation: In digital forensics, this technique can be crucial for analyzing digital evidence, discerning between human and AI-generated texts in legal investigations or cybercrime cases. Online Content Moderation: The system is exceptionally adept at analyzing and moderating content for digital platforms, ensuring adherence to community standards and regulatory requirements. It can automatically detect and redact sensitive or inappropriate content in real-time, making it invaluable for social media platforms, forums, and other online communities.

### BRIEF DESCRIPTION OF THE DRAWINGS

Embodiments will be described, by way of example only, with reference to the attached figures, wherein in the figures:

FIG. 1 is a high-level diagram of the system architecture.

FIG. 2 is a simplified diagram that further illustrates the overview of the system architecture, more clearly showing how the database of embeddings from an LLM encoder is used to build a classifier.

### DETAILED DESCRIPTION

The present disclosure relates to processing textual data to determine whether it is human-generated or machine-generated. The method utilizes an encoding module to convert text into high-dimensional feature vectors, capturing the semantic and syntactic properties essential for classification. The system segregates these feature vectors into distinct sets based on their origin for subsequent analysis. A subsequent classification mechanism analyzes these vectors using machine learning algorithms to distinguish between the text types. This mechanism employs pattern recognition and statistical analysis to differentiate between the characteristic patterns of human and machine-generated texts. This process is designed to be adaptable, providing a reliable means of verifying text authenticity across diverse digital applications. It can be deployed on new text samples outside of the training set.

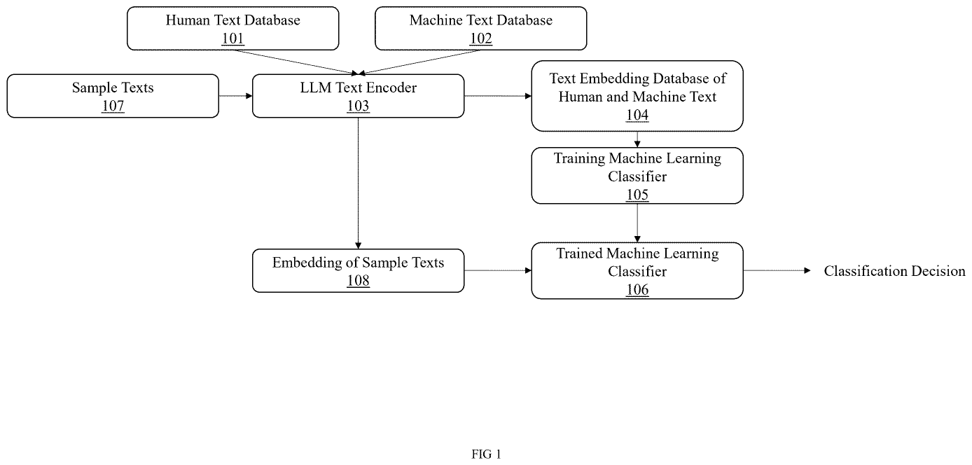

Steps 101 through 108 in FIG. 1 correspond to the overall pipeline of the system for classifying text as either human or machine generated. Step 101 involves receiving text input from various human written digital sources such as documents, emails, social media posts, and website content.

Step 102 involves receiving text input from various machine written sources. These can be based on asking large language models to rewrite the samples from the human written sources in Step 101.

Step 103 involves a pretrained LLM text encoder. The LLM Texas encoder converts human and machine generated texts into feature vectors, capturing the semantic and syntactic properties essential for classification.

Step 104 is a database of the text embeddings generated from Step 103 that maps the text embeddings back to the source generator of a given text embedding.

Step 105 is training a machine learning classifier to distinguish between human and machine generated texts using the text embedding database of human and machine text.

Step 106 is the trained machine learning classifier, which outputs a classification decision that points to the generator of a given text.

Step 107 is the collection sample texts to be analyzed and sent through the same text encoder in Step 103.

Step 108 is the embedding of the sample texts which will be sent to the trained machine learning classifier to provide a classification decision.

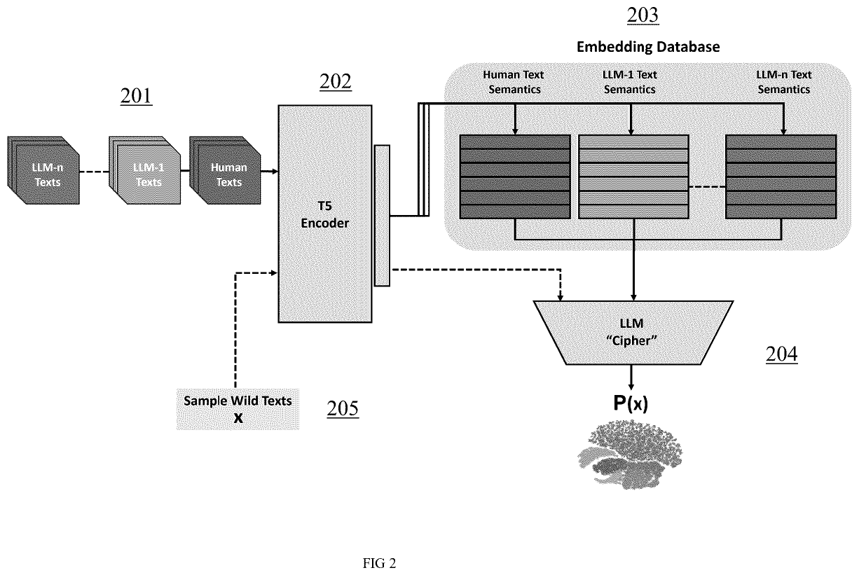

Steps 201 through 205 in FIG. 2 correspond to the overall pipeline of the system for classifying text as either human or machine generated with additional FIG. visuals for better understanding. Step 201 is collecting the texts from the various text generators, spanning from various LLMs and from human generated text.

Step 202 is an LLM encoder, illustrated in the FIG. as T5 as an example LLM encoder. The T5 encoder receives and processes the texts in 201 and converts them into embeddings.

Step 203 is a database containing the embeddings of all the texts from Step 201. It maps the text embeddings back to the source generator of a given text embedding.

Step 204 is a machine learning classifier that is trained from the data in Step 203 to attribute a text to a text generator.

Step 205 is the collection of sample texts that were not used to train the classifier in Step 204. These will be sent to the classifier to get a classification decision.

The features of the present invention which are believed to be novel are set forth below with particularity in the appended claims. However, modifications, variations, and changes to the exemplary embodiments of the invention described above will be apparent to those skilled in the art, and the described herein thus encompasses such modifications, variations, and changes and are not limited to the specific embodiments described herein.

1. A method for automatically detecting machine generated text, comprising:
receiving a plurality of text inputs;
converting the text inputs into feature vectors, wherein the feature vectors represent high-dimensional embeddings of the text inputs;
storing the feature vectors in a text embedding database;
analyzing the feature vectors using a training machine learning classifier to distinguish between human-generated and machine-generated texts;
classifying the text inputs based on their respective feature vectors and analysis; and outputting a representation of the classification.

2. The method of claim 1, wherein the encoding module utilizes a large language model encoder.

3. The method of claim 1, wherein classifying the text input by employing a contrastive learning-based KNN classifier.

4. The method of claim 1, wherein classifying the text input by employing a similarity matrix and Triplet Margin Loss.

5. The method of claim 1, wherein outputting a representation of the classification by graphically displaying clusters representing the classified text types.

6. A system for classifying text inputs comprising:
an input module configured to receive text inputs;
an encoding module coupled to the input module and configured to convert the text inputs into feature vectors;
a storage module for organizing and storing the feature vectors;
a classification module configured to analyze the feature vectors and classify the text inputs; and
an output module for visualizing the results of the classification.

7. The system of claim 6, wherein the encoding module is a large language model encoder.

8. The system of claim 6, wherein the classification module comprises at least one of an MLP classifier, a KNN classifier, and a contrastive learning-based KNN classifier.

9. The system of claim 6, further comprising a training module configured to employ a similarity matrix and Triplet Margin Loss to train the classification module.

10. The system of claim 6, wherein the output module generates visualizations that display clusters of feature vectors based on the classification.

11. A computer-implemented system for automatically detecting machine generated text, comprising:
a processor and a non-transitory computer-readable storage medium storing instructions that, when executed by the processor, cause the processor to perform a method comprising:
receiving a plurality of text inputs;
feeding the text inputs into an encoding module;
converting the text inputs into feature vectors, wherein the feature vectors represent high-dimensional embeddings of the text inputs;
storing the feature vectors in an text embedding database;
analyzing the feature vectors using a training machine learning classifier to distinguish between human-generated and machine-generated texts;
classifying the text inputs based on their respective feature vectors and analysis; and outputting a representation of the classification.

12. The method of claim 1, wherein the large language model encoder is frozen during use, such that weights of the encoder are not updated when processing text inputs for classification.

13. The method of claim 1, wherein the text embedding database maps each stored feature vector to an identifier of its source, the source being one of a human author or a specific machine text generator.

14. The method of claim 1, wherein the machine learning classifier comprises a multilayer perceptron (MLP) trained on the feature vectors from the text embedding database.

15. The method of claim 1, wherein the machine learning classifier comprises a K-Nearest Neighbors (KNN) classifier that uses Euclidean distance in an embedding space derived from the feature vectors.

16. The method of claim 3, wherein the contrastive learning-based KNN classifier is trained using a Triplet Margin Loss to minimize distances between embeddings of texts from the same source and maximize distances between embeddings from different sources.

17. The method of claim 16, further comprising generating a similarity matrix during training to facilitate the contrastive learning.

18. The method of claim 1, further comprising preprocessing the text inputs before converting them into feature vectors, wherein preprocessing includes at least one of tokenization, normalization, or removal of stop words.

19. The method of claim 1, wherein the plurality of text inputs includes synthetic machine-generated texts created by prompting one or more large language models to rewrite human-generated texts.

20. The method of claim 1, further comprising deploying the trained classifier to classify new text inputs in real-time for at least one application selected from: content moderation, academic integrity verification, phishing detection, fake review identification, or digital forensics.

21. (canceled)

22. (canceled)
